(19) United States
(12) Patent Application Publication
(10) Pub. No.: US 2021/0108703 A1
(43) Pub. Date: Apr. 15, 2021

(54) RESTRICTION FOR A VIBRATION DAMPER

(71) Applicant: ZF FRIEDRICHSHAFEN AG, Friedrichshafen (DE)

(72) Inventors: Jörg RÖSSELER, Ruppichteroth (DE); Aleksandar KNEZEVIC, Eitorf (DE)

(21) Appl. No.: 17/064,838

(22) Filed: Oct. 7, 2020

(30) Foreign Application Priority Data
Oct. 10, 2019 (DE) 10 2019 215 561.8

(51) Int. Cl. F16F 15/121

(52) U.S. Cl. CPC F16F 15/1215; E21B 17/1021

(57) ABSTRACT

A restriction for a vibration damper includes a support with an annular groove in which is arranged an annular element with variable diameter which is radially preloaded by an elastic limiting element. The annular element together with a flow guiding surface forms the restriction. The cross section of the restriction decreases with increasing flow velocity within the restriction. The support has a cover element which forms the annular groove at least partially with a base part of the support.

### BACKGROUND OF THE INVENTION

### 1. Field of the Invention

The invention is directed to a restriction for a vibration damper.

### 2. Description of Related Art

A damping valve device in which a radially expandable annular element together with a flow guiding surface forms a restriction which generates a higher damping force and, therefore, a progressive damping force characteristic with increasing flow velocity is known from DE 10 2016 210 790 A1.

The annular element is chambered in an annular groove of a support, particularly a support disk, and is preloaded radially inward by an elastic limiting ring. The annular element can have a radial slot in order to reduce the forces necessary for an expanding movement.

### SUMMARY OF THE INVENTION

The diameter of the support disk must always be adapted to the diameter of the cylinder. Measured against the restriction, the support disk is a very appreciable component part with respect to cost. Therefore, it would be useful to further develop the restriction such that a larger variety of vibration dampers could be outfitted with a restriction.

One aspect of the invention is that the support has a cover element that forms the annular groove at least partially with a base part of the support.

The cover element serves as a standardized component part to cover a wide range of different diameter types in vibration dampers with one base part as far as possible.

For example, the base part for the vibration damper is configured with the smallest possible inner diameter, and the cover element radially protrudes over a cover side of the base part that limits the annular groove. An additional component part would have to be introduced in this case, but this component part could be produced very easily as a stamped part.

In a further advantageous configuration, it can be provided that the cover element is supported at an axial shoulder of the base part. Consequently, no special fastening surfaces need be introduced at the base part.

A further option is that the cover element is formed by a flexible plate. With a flexible plate, a positive pressure function could be implemented at the restriction.

In one mode of construction, it can be provided that the cover element is connected to the base part via at least one rivet connection. The rivet connection does not necessarily require an additional rivet as component part. The rivet connection can also be generated by an axial projection of the base part.

Alternatively, the rivet connection can serve as a pivot bearing for at least one swivelable ring segment of the annular element. In this case, a rivet penetrates the base part and the cover element.

In order to facilitate the overall assembly of the restriction, the cover side of the base part supporting the cover element has a smaller diameter than the limiting element. In this case, the annular element can be assembled very easily; in particular, the limiting ring can easily be slipped over the cover side of the base part. The cover element would provide for the closure function of the limiting ring inside of the annular groove.

In a particularly simple mode of construction of the support, this support has two separate cover disks and a separate spacer ring. A cover disk and the spacer ring then form the base part. A cover disk would then be the individually exchangeable cover element within the meaning of the invention.

It can also be provided that an inner sleeve has securing surfaces for holding the cover disks together.

### BRIEF DESCRIPTION OF THE DRAWINGS

The invention will be described more fully with reference to the following description of the figures. The drawings show:

FIG. 1 is a section through a vibration damper in the area of the damping valve device;

FIG. 2 is a detailed view of the support with additional cover element;

FIG. 3 is cover element as elastic disk

FIGS. 4 and 5 are views of the support with rivet connection as pivot bearing for annular element; and

FIG. 6 is the support with inner sleeve.

### DETAILED DESCRIPTION OF THE PRESENTLY PREFERRED EMBODIMENTS

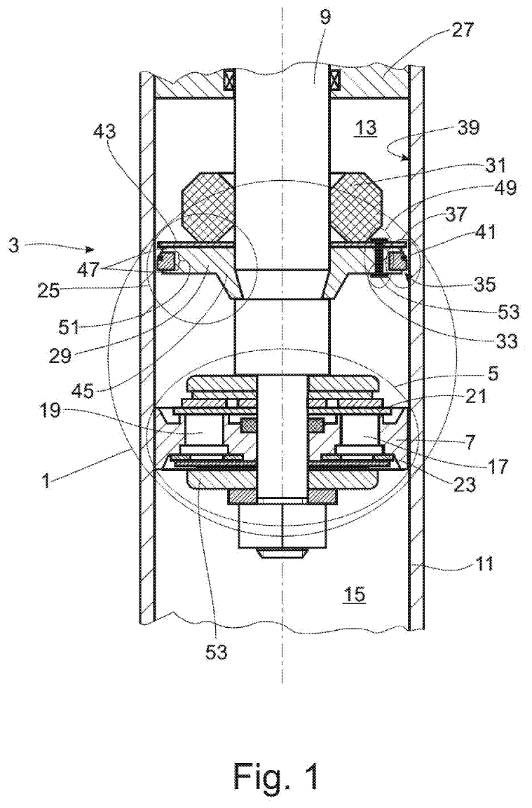

FIG. 1 shows a damping valve device 1 for a vibration damper 3 of any constructional type, shown only partially. The damping valve device 1 comprises a first damping valve 5 with a damping valve body constructed as a piston 7 and fastened to a piston rod 9.

The damping valve body 7 divides a cylinder 11 of the vibration damper into a work chamber on the piston rod side and a work chamber remote of the piston rod, both work chambers being filled with damping medium. Through-channels are formed in the damping valve body 7 for a respective throughflow direction on different pitch circles. The configuration of the through-channels is to be regarded as exemplary only. An outlet side of the through-channels 17; 19 is at least partially covered by at least one valve disk 21; 23.

Additionally, the vibration damper has a rebound stop 25 that makes contact with a cylinder-side stop surface, e.g., piston rod guide 27, starting from a defined extension movement of the piston rod 9.

The rebound stop 25 comprises a support 29, which is directly secured to the piston rod through a positive engagement connection. An annular elastomer element 31, for example, is placed on an upper side of the support 29 and is held via a slight radial preloading even during an oscillating movement of the piston rod 9. Onward from the stop point at the stop surface, the elastomer element 31 acts as additional supporting spring.

The support 29 has a circumferential groove 33 in which an annular element 35 with adjustable diameter is guided. This annular element 35 is radially elastic and forms a valve body for a restriction 37 as part of the damping valve device 1. The annular element 35 forms the restriction with an inner wall of cylinder 11, which inner wall 39 forms a flow guiding surface. In principle, the invention can also be formed in a support disk independent from the rebound stop.

The annular element has at the outer side thereof a limiting ring 41 constructed, as a retaining ring. Pressure compensation channels 43, which connect an outer lateral surface 45 of the annular element 35 to the one groove base of the circumferential annular groove 33, are formed radially inwardly of the annular element.

At a piston rod velocity in a first operating range, e.g., less than 1 m/s, the restriction 37 is completely open. The damping force is then generated only by the through-channels 17; 19 in combination with valve disks 21; 23. With flow impinging on valve disks 21; 23, the valve disks 21; 23 lift from their valve seat surface 47; 49. The lifting movement is limited in each instance by a supporting disk 51; 53.

In a second operating range with a piston rod velocity greater than the limit velocity of the first operating range, i.e., greater than the 1 m/s which was indicated by way of example, the annular element 35 transitions into a restriction position and, in so doing, executes a closing movement in direction of the flow guiding surface 39. As a result of the high flow velocity of the damping medium in the restriction 37, which is shaped as an annular gap, a negative pressure forms leading to a radial expansion of the annular element 35. However, in order to preclude blockage of the restriction 37 the defined minimum cross-sectional opening area of the limiting ring 41 is observed. Alternatively, the annular element 35 can have an axially oriented profile on its lateral surface facing in direction of the inner wall, which axially oriented profile determines a minimum restriction cross section of the restriction. In this case, the limiting ring 41 need only exert a return force on the annular element.

To carry out the restriction 37 with a standardized support 29, the support 29 has a cover element 43 that forms the annular groove 33 at least partially with a base part 45 of the support. To this end, the cover element 43 determines the maximum restriction cross section with the inner wall 39 of the cylinder 11 when the annular element occupies its initial position in the annular groove 33.

The cover element 43 covers a cover side 47 of the base part 45 limiting the annular groove 33. The cover element 43 is fastened to the base part 45 via at least one rivet connection 49. In this constructional variant, the base part 45 has two cover sides 47 and a spacer sleeve 51 which are produced, e.g., as a rotational part from an annular blank. At least one rivet element 53 penetrates the cover element 43 and the two cover sides 47. The at least one rivet element 53 may also penetrate the spacer sleeve 51 depending on the dimensioning of the base part 45.

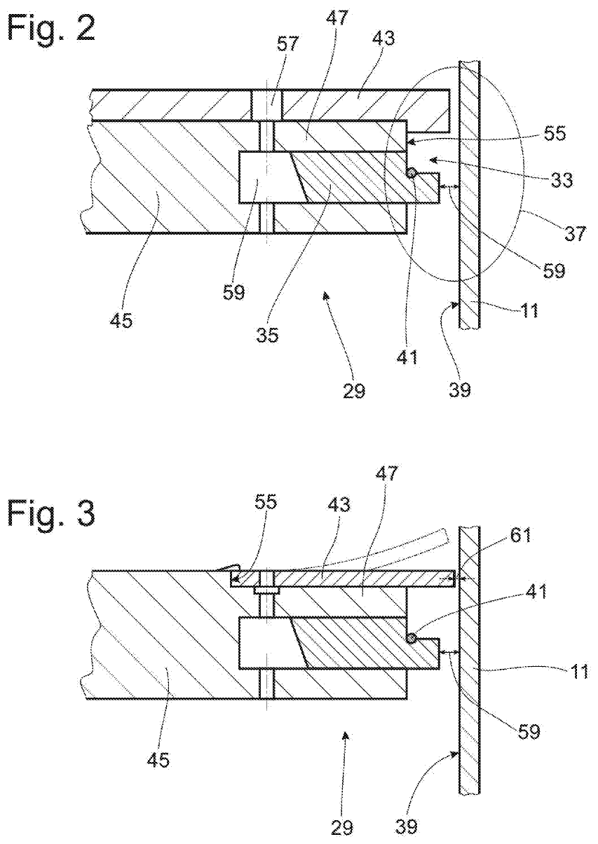

In the construction according to FIG. 2, the cover element 43 is supported at an axial shoulder 55 of the base part 45. This axial shoulder 55 is preferably formed by a circumferential lateral surface of the base part 45. It is not compulsory that the cover element 43 itself comprises a metal material; it can also be constructed as a plastic cover. Depending on the construction, a channel portion 57, which connects a rear chamber 59 inside of the annular groove 33 to a work chamber 13; 15 in cylinder 11, can be implemented in the cover element 43. The incident flow in the rear chamber 59 proceeding from the work chambers serves to control the annular element 35 and reinforces the effect of the actuation through the pressure drop inside of a restriction cross section 59 of the restriction which results in the above-mentioned radial expansion of the annular element 35.

In principle, the base part 45 can also have a stepped cover side 47 as shown in FIG. 3, so that the shoulder 55 would be displaced radially inward proceeding from the outer circumferential lateral surface. It is also represented symbolically in FIG. 3 that the cover element 43 is formed by a flexible disk. With a flexible disk as cover element, a positive pressure function can be achieved in which an increase in the distance 61 between the cover element and the inner wall 39 of the cylinder 11 is achieved. When distance 61 is greater, the flow velocity and therefore the expansion force between the cover element 43 and the inner wall 39 are also decreased. Accordingly, the annular element 35 compresses radially so that the damping effect of the restriction 37 decreases overall.

For example, the cover element 43 is simply staked with the cover side 47 of the base part. In so doing, volume portions of the cover side 41 are simply displaced to the upper side of the cover element 43.

In the configuration in both FIG. 2 and FIG. 3, the cover side 47 of the base part 45 carrying the cover element 43 has a smaller diameter than the limiting element 41. During assembly of the limiting element, the annular element 35 can be inserted into the annular groove 33 already by spreading apart radially over the cover side 47. In this way, the limiting ring 41 can be guided into the annular element 35 by an axial assembly movement.

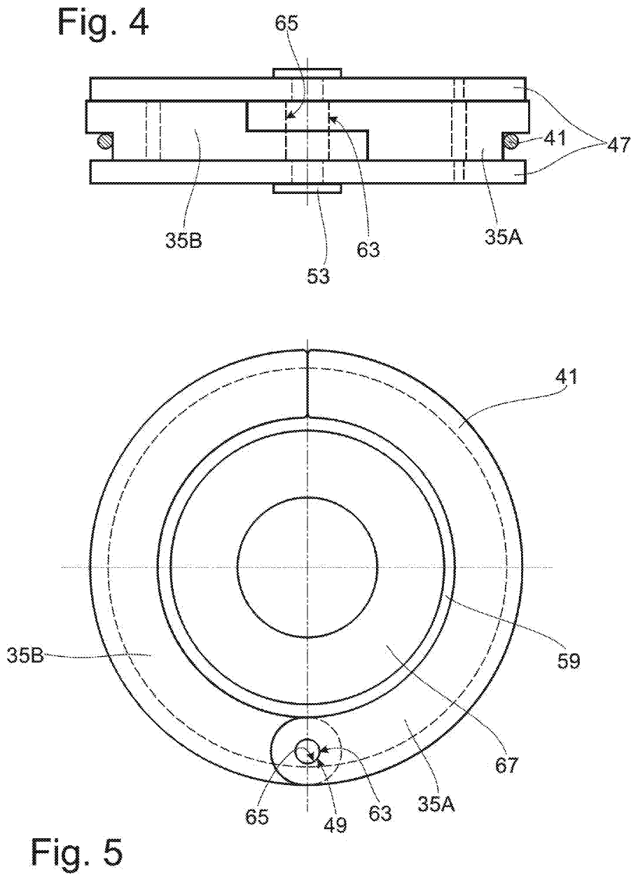

It has already been shown with reference to FIG. 1 that the cover element 43 can be connected to the base part via at least one rivet connection. In the construction according to FIGS. 4 and 5, the annular element 35 comprises at least one ring segment 35A; 35B which is swivelable around a pivot bearing. Two ring segments 35A; 35B are used in this variant. When FIG. 4 are FIG. 5 are viewed in conjunction, it can be seen that the rivet connection 49 serves as a pivot bearing 63 for the ring segments 35A; 35B which overlap in circumferential direction in the area of the pivot bearing 63 and have a through opening 65 for the rivet element 53 in each instance.

Alternatively, in contrast to FIGS. 1 to 5, this rivet connection 49 allows a construction of the support having two separate cover disks 47 and a separate spacer ring 67. In this way, any combinations can be created through the selection of cover disks 47 and spacer ring 67.

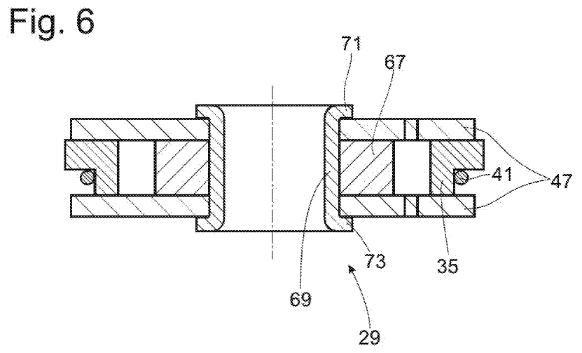

The basic construction of the support 29 according to FIG. 6 corresponds to the construction according to FIGS. 4 and 5. In contrast, an inner sleeve 69 having securing surfaces 71; 73 for holding the cover disks 47 together is used in FIG. 6. For assembly, the cover disks 47 and the spacer ring are fitted to the inner sleeve 69 and at least one of the securing surfaces 71; 73 on one of the cover disks 47 is subsequently deformed. The other securing surface of the inner sleeve can have been integrally formed beforehand and can form a mounting support for the cover disk 47.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A restriction for a vibration damper, comprising:
an elastic limiting element;
an annular element with variable diameter which is radially preloaded by the elastic limiting element; and
a support with an annular groove in which is arranged the annular element, wherein the annular element together with a flow guiding surface forms the restriction, the support comprising:
a base part; and
a cover element which forms the annular groove at least partially with the base part;
wherein a restriction cross section of the restriction decreases with increasing flow velocity within the restriction.

2. The restriction according to claim 1, wherein the cover element radially protrudes over a cover side of the base part that limits the annular groove.

3. The restriction according to claim 1, wherein the cover element is supported at an axial shoulder of the base part.

4. The restriction according to claim 1, wherein the cover element is a flexible plate.

5. The restriction according to claim 1, wherein the cover element is connected to the base part via at least one rivet connection.

6. The restriction according to claim 5, wherein the at least one rivet connection is as pivot bearing for at least one swivelable ring segment of the annular element.

7. The restriction according to claim 2, wherein the cover side having the cover element has a smaller diameter than the elastic limiting element.

8. The restriction according to claim 1, wherein the support has two separate cover disks and a separate spacer ring.

9. The restriction according to claim 8, wherein an inner sleeve has securing surfaces for holding the two separate cover disks together.
